(19) United States
(12) Patent Application Publication
(10) Pub. No.: US 2006/0136244 A1
(43) Pub. Date: Jun. 22, 2006

(54) Method to dynamically view and update adaptive process document

(76) Inventors: Daniel DeFolo, Campbell, CA (US); Cathrin Callas, San Carlos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/020,058

(22) Filed: Dec. 21, 2004

(51) Int. Cl. G06Q 99/00

(52) U.S. Cl. 705/1

(57) ABSTRACT

A computer-implemented method for managing a partially completed dynamic process execution (PCDPE). The PCDPE represents a dynamic process that is partially completed by a user. The method includes ascertaining whether a change has occurred to at least one of a prompt component and a response component associated with the dynamic process. The method also includes, if a change has occurred, ascertaining whether a completed process step of the PCDPE requires updating responsive to the change. The method further includes, if the completed process step requires updating, performing an update action on the completed process step.

### BACKGROUND OF THE INVENTION

Completing a complex task may involve performing a sequence of steps in a particular order. The particular individual steps that make up the sequence of steps required to complete a given task may differ depending on the nature of the task to be performed, the status or identity of the user, etc.

Consider for example the task of approving an invoice for goods purchased. If the invoice is for a relatively small amount (e.g., five dollars) and the employee executing the invoice approval process is a high-level manager, the invoice approval task may involve only a few steps. However, if the invoice is for a large amount (e.g., over a million dollars), the invoice approval task may involve additional steps, such as verifying that the goods have been satisfactorily received and that funds are actually available for paying the invoice once the invoice is approved. As another example, if the employee executing the invoice approval process is a low-level employee, additional steps may also be required to ensure that the employee in fact has sufficient authority to approve the invoice.

To ensure that the proper sequence of steps is executed for a given task by a particular user, dynamic process documents have been employed. A dynamic process document represents an expert system that is database-driven and provides guidance to a given user with regard to the specific steps and the proper step sequence for accomplishing a given task.

With respect to the aforementioned invoice approval task, an invoice approval dynamic process document may have twenty steps. If the invoice amount to be approved is small, steps 3, 5, and 20 may be required, for example. In this case, prompts pertaining to steps 3, 5, and 20 may be displayed in sequence, and the user may respond to the prompts to complete the approval task of a small invoice. If the invoice amount to be approved is large, steps 3, 7, 9, 11, 13, 15, 16, 17, and 20 may be required, for example. In this latter case, prompts pertaining to steps 3, 7, 9, 11, 13, 15, 16, 17, and 20 may be displayed in sequence, and the user may respond to these prompts to complete the approval task of the larger invoice.

From time to time, an organization may wish to revise its processes. For example, the invoice approval process version 1.0 may be revised at some point, resulting in an invoice approval process version 2.0. In this version 2.0, the approval of a large invoice may, for example, necessitate a greater number of steps than the number of steps required pursuant to invoice approval process version 1.0.

If a user is in the middle of approving a large invoice using invoice approval process 1.0, the updating of the invoice approval process to invoice approval process 2.0 by his company poses certain dilemmas for that user. If the user continues with invoice approval process 1.0, the approval may not be deemed “proper” when completed since some of the new steps required by invoice approval process 2.0 would have been missed. If the user starts all over with invoice approval process 2.0, the work partially performed using invoice approval process 1.0 is essentially wasted.

If the user chooses to salvage the partially completed work by attempting to manually identify and perform selected steps to bring the partially completed work up to the standard required by invoice approval process 2.0, there is always a risk that some steps may be missed or incorrectly identified. For example, if the user already finished six steps (e.g., steps 3, 7, 9, 11, 13, 15) of the nine required steps pursuant to invoice approval process 1.0, and invoice approval process 2.0 requires the addition of certain steps, the elimination of certain steps, and the changing of the sequencing order of certain other steps, there is a high risk that a user attempting to salvage the partially finished work may not correctly identify the needed remedial action required to bring the partially completed work up to the standard required by invoice approval process 2.0. For some complex processes where one or more subsequent steps may depend upon the responses to one or more preceding steps, to manually identify the remedial action required to properly salvage the partially completed work may be extremely difficult.

As illustrated by the examples above, incorporating updates into a partially completed process may be a daunting task for a user in the prior art. What is needed is a mechanism to determine when a change impacts a particular user and automatically updates a user's response based on the criteria of the changes. Also, the mechanism needs to have the ability to identify the items that cannot be automatically updated and to guide the user through these changes so that the completed process reflects the most updated version.

### SUMMARY OF INVENTION

The invention relates to a computer-implemented method for managing a partially completed dynamic process execution (PCDPE). The PCDPE represents a dynamic process that is partially completed by a user. In an embodiment, the method includes ascertaining whether a change has occurred to at least one of a prompt component and a response component associated with the dynamic process. The method also includes, if a change has occurred, ascertaining whether a completed process step of the PCDPE requires updating responsive to the change. The method further includes, if the completed process step requires updating, performing an update action on the completed process step.

In another embodiment of the invention, the method includes an article of manufacture comprising a program storage medium having computer readable code embodied therein. The computer readable code is configured to manage a PCDPE, where the PCDPE represents a dynamic process that is partially completed by a user. The method further includes a computer readable code for ascertaining whether a change has occurred to at least one of a prompt component and a response component associated with the dynamic process. The method also includes, if the change has occurred, computer readable code for ascertaining whether a completed process step of the PCDPE requires updating responsive to the change. The method further includes, if the completed process step requires updating, computer readable code for performing an update action on the completed process step.

In yet another embodiment of the invention, the method includes a computer-implemented method configured for managing a PCDPE. The PCDPE is associated with a given version of a dynamic process. The PCDPE also involves at least one completed process step and at least one incomplete step. The method also includes ascertaining whether a subsequent version of the dynamic process involves a change to the at least one completed process step. The method further includes, if a change exists, performing an update action on at least one completed process step.

These and other features of the present invention will be described in more detail below in the detailed description of various embodiments the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

Prior art FIG. 1A shows examples of prompts that may be found in a dynamic process document.

Prior art FIG. 1B shows components of a database that may be associated with a dynamic process document.

Prior art FIG. 1C show examples of database entries that may be found in a database that may be associated with a dynamic process document.

Prior art FIG. 2A shows an example of a prompt in which the response type is a free-form text.

Prior art FIG. 2B shows an example of a prompt in which the response type has been changed to a response type of a combo box in the newer version.

FIG. 3 shows, in an embodiment of the invention, components, in addition to those components that may be found in the prior art, which may exist in a prompt database.

FIG. 4 shows, in an embodiment of the invention, components, in addition to those components that may be found in the prior art, which may exist in a response database.

FIG. 5 shows, in an embodiment of the invention, a prompt database entry having both the prior art and new components.

FIG. 6 shows, in an embodiment of the invention, an example of an entry in a response database.

FIG. 7 shows, in an embodiment of the invention, the managed update system displaying a prompt that may reflect previous version prompt and response component along with the newer version prompt.

FIG. 8A shows, in an embodiment of the invention, a high-level view of an algorithm for managing changes to a dynamic process while the user has only partly completed that dynamic process.

FIG. 8B shows, in an embodiment of the invention, an algorithm for managing changes to a dynamic process while the user has only partly completed that dynamic process.

FIG. 9 shows, in an embodiment of the invention, an algorithm for the update process, either a required update or a recommended update, that a managed update system may perform.

### DETAILED DESCRIPTION OF VARIOUS EMBODIMENTS

The present invention will now be described in detail with reference to various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general purpose computer and/or a dedicated computing device when appropriately programmed and may include a combination of a computer/computing device and dedicated/programmable circuits adapted for the various tasks pertaining to embodiments of the invention.

As mentioned before, a dynamic process document relates to an expert system that is database-driven and provides guidance as the user works through a process to complete a task. A dynamic process document, when executed, may be able to determine subsequent steps that are relevant to the user's task based on the user's earlier response(s). To facilitate discussion, prior art FIG. 1A shows an example of a 5-step process. In this example, depending upon how the user responds to step 102, the dynamic process may display steps 104, 104a, 104b, and 104c or the dynamic process may bypass those steps entirely and proceed to step 2.2. Functionally speaking, the dynamic process provides navigation support as the user goes through a process. As a result, the process may incorporate more steps and conditions without placing the burden on the user to determine the steps that are essential to complete a task.

The navigational support of a dynamic process is possible because the dynamic process is generally associated with a database. The database contains various components (fields) that make up a prompt. As discussed herein, a prompt relates to a mechanism employed to navigate a user through a dynamic process. Examples of prompts are steps 102, 104, 104a, 104b, and 104c in prior art FIG. 1A.

Prior art FIG. 1B shows components of a database such as key, location, title, selection criteria, prompt type, response type, prompt text and response. These components may be stored in the database as part of a database entry. Prior art FIG. 1C provides examples of database entries. These database entries correspond to the steps shown in prior art FIG. 1A. For example, step 102 in prior art FIG. 1A corresponds to a database entry 130. The other two database entries 140 and 150 correspond respectively to steps 104 and 104a.

Using database entry 130 as an example, the various components that may be found in a database entry in the prior art are discussed. Key component 110 is a unique identifier used to differentiate each database entry. In this database entry example, key component 110 has a value of k1. As a result, no other entry may have a value of ‘k1’.

Another component that may exist in a database entry is location component 112. Location component 112 identifies the order of the step corresponding to that database entry in the overall dynamic process. In database entry 130, location component 112 has a value of ‘2.1.2’, which corresponds to step 102 in prior art FIG. 1A.

A component that may be optional is title component 114. Title component 114 provides a label to a prompt. As can be seen in prior art FIG. 1A, step 102 has no title. As a result, title component 114 has a value of ‘none’ in database entry 130.

Selection criteria component 116 is yet another component that may be present in a database entry. The purpose of selection criteria component 116 is to define the condition that triggers the execution of its associated step. In database entry 130, selection criteria component 116 has a value of ‘always’, which means that step 102 in prior art FIG. 1A is always executed. Likewise, in database entry 140, selection criteria component 146 has a value of ‘if k1 is no’. Thus, if response in step 102 (prior art FIG. 1A) equals to a value of ‘yes’ then step 104 (prior art FIG. 1A), which is associated with database entry 140 (prior art FIG. 1C) is not executed.

Another component, prompt type component 118, identifies the type of prompt that is used to execute a specific step. Examples of prompt type component 118 may include text and script-based text. In database entry 130, prompt type component 118 has a value of ‘text’, which means that the prompt is displayed to the user in a text format. As discussed herein, script-based text relates to a syntax for calling a specific program.

Another component is response type component 120, which identifies the format of the response. Examples of response type component 120 include free-form text, checkbox, radio button, and combo box. Response type component 120 has a value of ‘yes/no’ (radio button), which means that the user may choose only ‘yes’ or ‘no’ as a response to this particular step.

The next component, prompt text component 122, provides the exact text or script code that an expert system uses to guide the user through a process (i.e., the actual text that is displayed to the user). Examples of prompt text component 122 may include text or image. Note that prompt text component 122 may also contain a script code that the expert system may run to create the text for the prompt.

Yet another component of a database entry is response component 124. Response component 124 is the user's reply. In database entry 130, the response component 124 has a value of ‘none’, which indicates that the user has not provided a response to this step.

On the whole, the dynamic process represents an effective mechanism for guiding a user through a process, especially a complex one. However, managing changes to a dynamic process while the user has only partly completed that dynamic process has been challenging in the prior art, especially for a partially completed dynamic process execution (PCDPE). As discussed herein, a PCDPE relates to a dynamic process that is partially completed by a user.

Managing changes in the prior art has been laborious because changes usually occur at the process level. Thus, to take advantage of a change, a user generally has to upgrade to the next version of the dynamic process. To facilitate discussion, prior art FIG. 2A shows a prompt in which the response type is a free-form text in process version 1.0. In version 2.0 for the dynamic process, the prompt has been changed to show a response type of a combo box, as shown in prior art FIG. 2B. In the prior art, to take advantage of the new response type, the user has to use the newer version. Thus, if a user has begun the task using process version 1.0, the combo box is unavailable to the user who utilizes process version 1.0.

The next example further illustrates the challenge faced by a user when changes occurred. For example, User A has begun a task using process version 1.0 of a dynamic process. Before completing that dynamic process, process version 2.0 is introduced which contains changes that may impact the PCDPE. User A may choose to switch to the new version, which means that the time spent on the previous version has been wasted.

Another route User A may opt for is to manually determine if the changes impact already completed steps of the current complex process and to incorporate the changes as needed. Problems exist with this method because the user may not always make the correct decision. Furthermore, User A may not be able to identify all the steps that have been impacted; thus, the user may miss out on important changes. Alternatively, User A may choose not to upgrade to the newer version. However, the user runs the risk of being requested to execute the process again using the newer version if the changes happen to impact the quality of the task or its acceptance.

In accordance with embodiments of the present invention, there is provided a managed update system. As discuss herein, a managed update system relates to a database-driven system that guides a user through a complex process while managing changes to that process. Further, the managed update system manages changes on a prompt-by-prompt level instead of a process level. To enable the managed update system to handle changes on a prompt-by-prompt level, an inventive database structure has been created.

In an embodiment of the invention, the inventive database structure consists of 2 separate databases: a prompt database and a response database. Although, the 2 separate databases may be stored as one large database, the logical splitting of the database allows for additional efficiency.

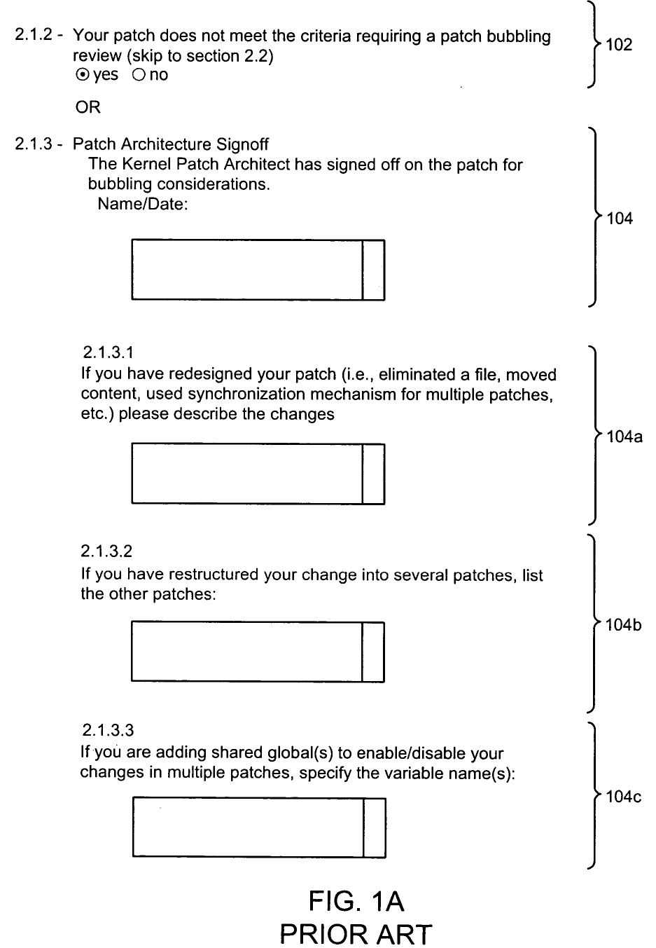

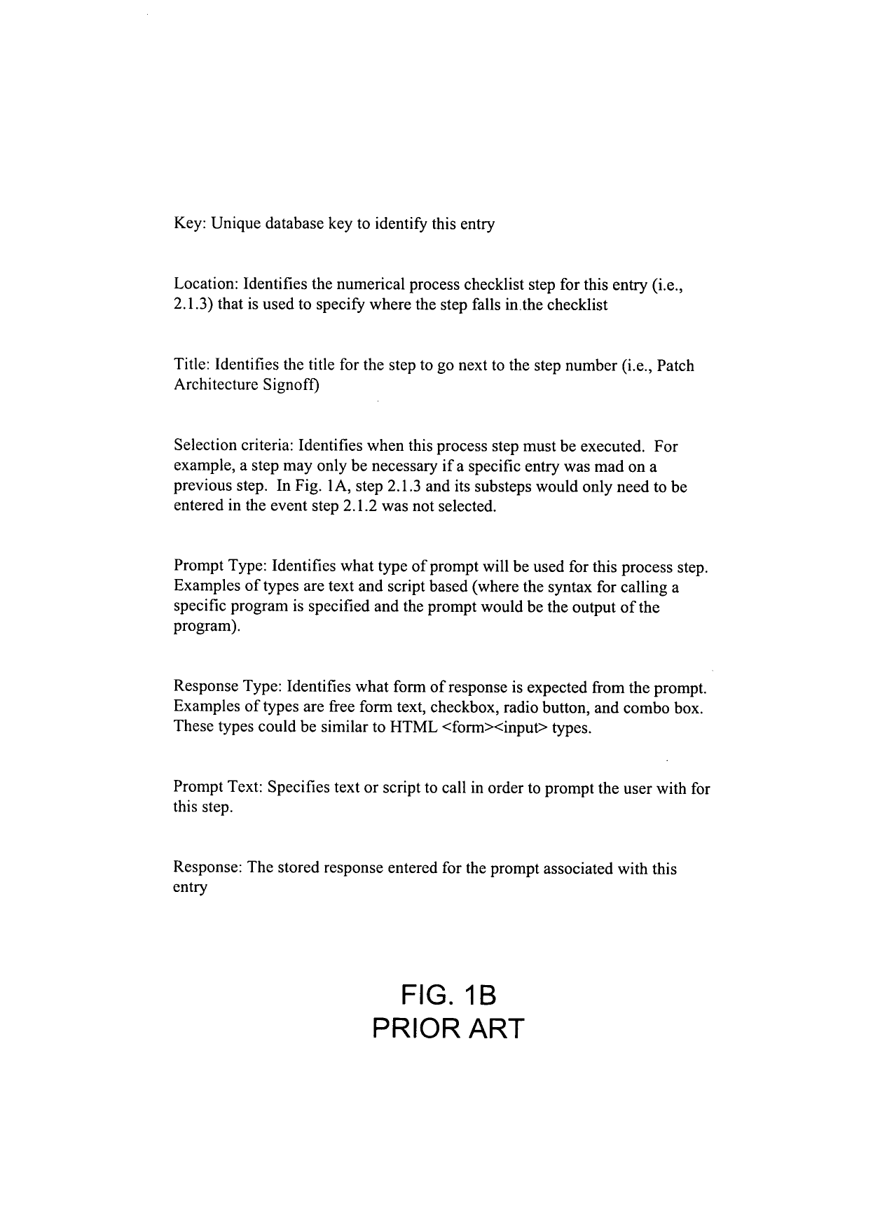

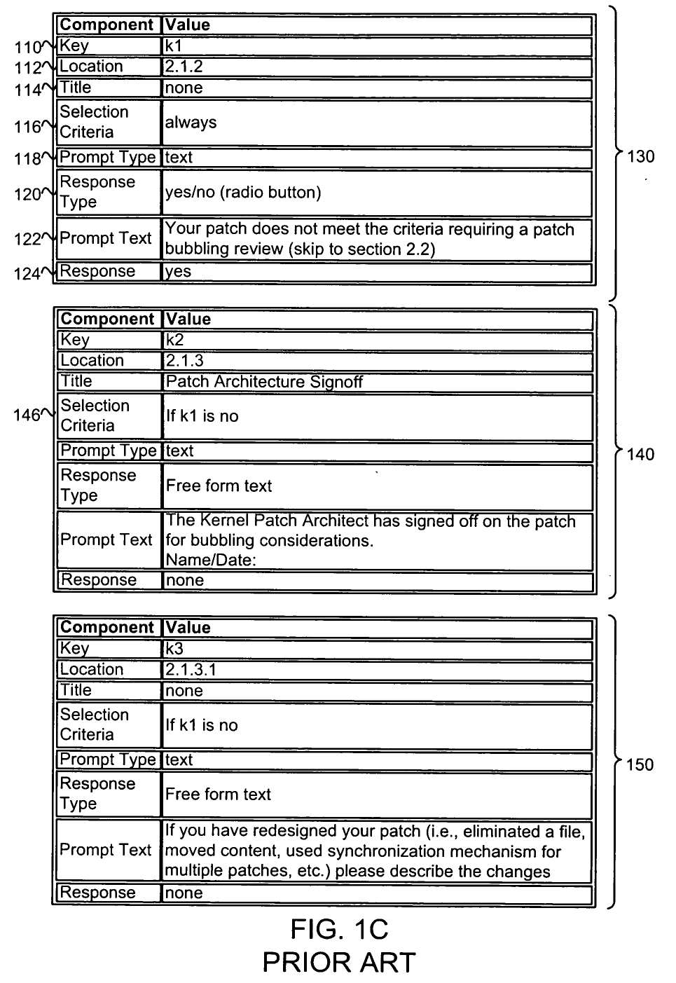

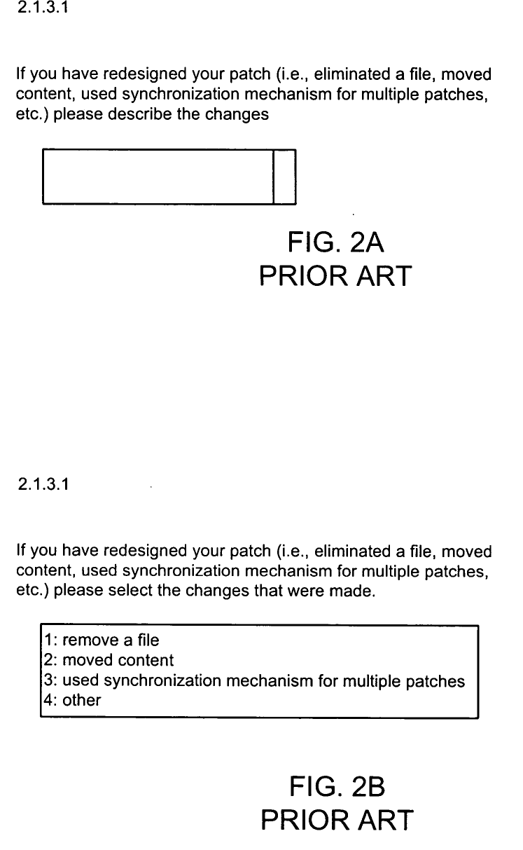

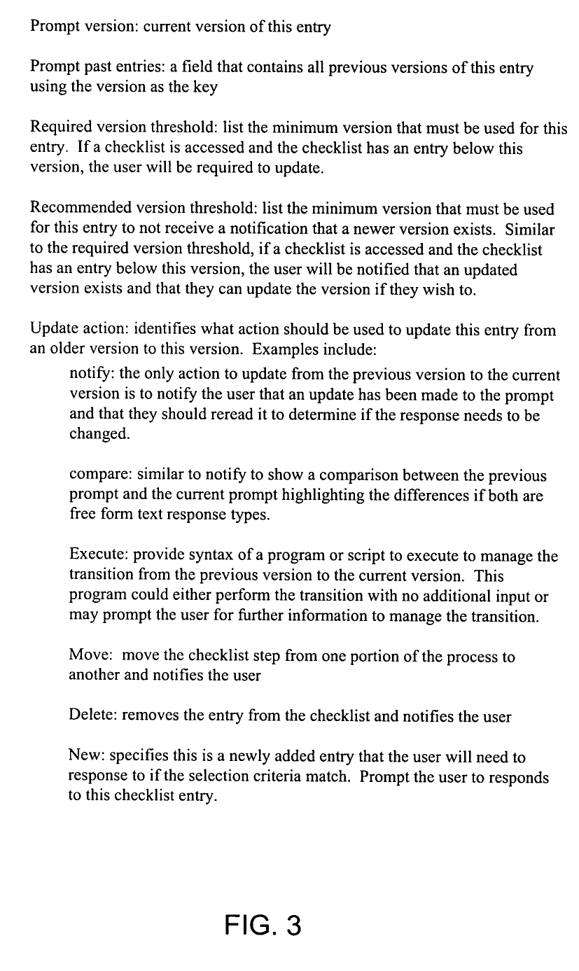

All components in the prior art, except the response component, may be components in the prompt database. FIG. 3 shows additional new components that may exist in the prompt database. New components include prompt version, prompt past entries, required version threshold (required update version), recommended version threshold (recommended update version), and update action.

With respect to the response database, the response component that may be found in the prior art is now stored in the response database along with some additional new components.

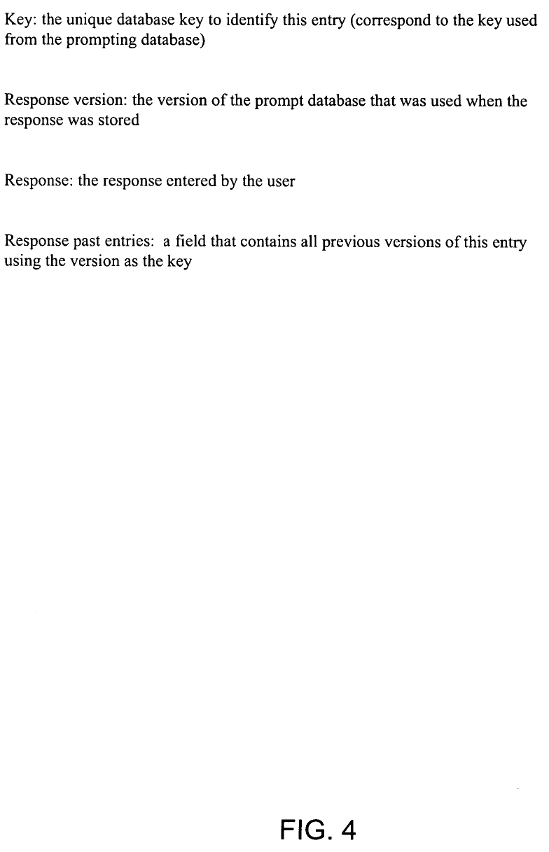

FIG. 4 shows the new components in the response database which may include key, response version, and response past entries.

With the inventive database structure, the managed update system is able to guide a user through a process and also handle version changes to a PCDPE. For example, a user has completed steps 1 and 2 in a twenty-steps dynamic process. After these two steps are completed, the process is updated. Accordingly, the user is now involved in a PCDPE that is being updated. The next time the user accesses the PCDPE, the managed update system compares the current PCDPE against the prompt and response databases to determine whether any component has been updated or changed recently. In other words, each step is sequentially analyzed by the managed update system so that the changes can be presented to the user for updating in an efficient manner.

In the example above, the managed update system analyzes step 1 and determines that there is an updated version of step 1. Since step 1 has already been completed by the user, the managed update handles the changes based on the update action component that is associated with the change. As discussed herein, update action relates to an action that when performed, updates an entry in the previous version to the newer version.

For example, the update action associated with step 1 maybe a compare action. In a compare action, the managed update system displays the previous version of the prompt text and the response along with the prompt text and response type of the newer version. The user is then asked to re-enter the response using the date type associated with the newer version. The response given by the user is then stored in the response database as a new entry.

Upon the completion of step 1, the managed update system then proceeds to the next step. At step 2, the managed update system ascertains that there have been no updates and proceeds to the next step. From step 3 and onward, only the latest version of each prompt is displayed since these steps are still outstanding. The managed update system continues through the rest of the process in a sequential order until the last step has been completed by the user. If the user leaves the dynamic process before completing the entire process, then the next time the user accesses the PCDPE, the managed update system will go through the same procedure to check for the latest updates so that the most updated version may be made available to the user.

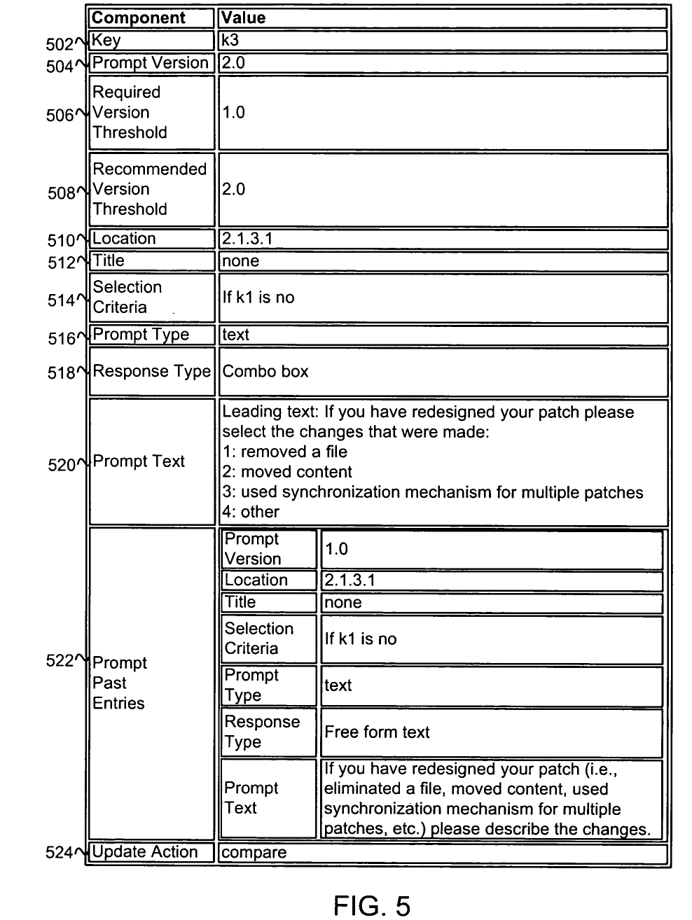

The invention may be better understood with reference to the figures and discussions herein. To facilitate discussion, FIG. 5 shows a prompt database entry having both the prior art and new components. Key component 502, which is a component in the prior art, has a value of ‘k3’. A new component, prompt version component 504, displays the current version of the entry. In this example, the value associated with prompt version component 504 is ‘2.0’.

Two additional new components are also provided: required version threshold component 506 and recommended version threshold component 508. Required version threshold component 506 represents the threshold version of the prompt associated with the user's past response below which updating is mandatory. For example, if the user's past response is associated with a prompt version that is equal to or older (i.e., 0.7) than the required version threshold component 506 (i.e., 1.0), the step 2.1.3.1 of FIG. 5 has to be executed again to update the PCDPE. Recommended version threshold component 508 represents the threshold version of the prompt associated with the user's past response below which updating is recommended but is not mandatory. Thus, in the example of FIG. 5, if the user's past response is associated with a prompt version that is older (i.e., 1.5) than the recommended version threshold component 508 (i.e., 2.0), the execution of step 2.1.3.1 with the new prompt is recommended but is not mandatory.

In the event that the user's past response is equal to or newer than recommended version threshold component, but is not equivalent to the most recent prompt version, a courtesy notification may be raised as a flag to inform the user that a newer version exists; however, the user is neither required nor recommended to update to the new version. Since prompt version component 504 is equal to recommended version threshold component 508 in the example shown in FIG. 5, courtesy notification does not need to occur.

The next few components (location component 510, title component 512, selection criteria component 514 and prompt type component 516) are fields that already existed in the prior art. Response type 518 is also a component from the prior art. In this example, response type 518 has changed from a free form text to a combo box as the prompt version is updated from 1.0 to 2.0. As a result, the value for prompt text 520 has changed to reflect the new combo box list.

Another component, prompt past entries component 522, is a new component that contains prompt database entries associated with one or more previous versions of the prompt. Since prompt past entries component 522 is a historical record, the required version threshold, recommended version threshold and the update action components are not needed.

Yet another new component that may be found in the prompt database is update action 524. Update action 524 identifies the action that may be used to update an entry from an older version to the newest version. Examples of update action include notify, compare, execute, move, delete, and new. These will be discussed later herein.

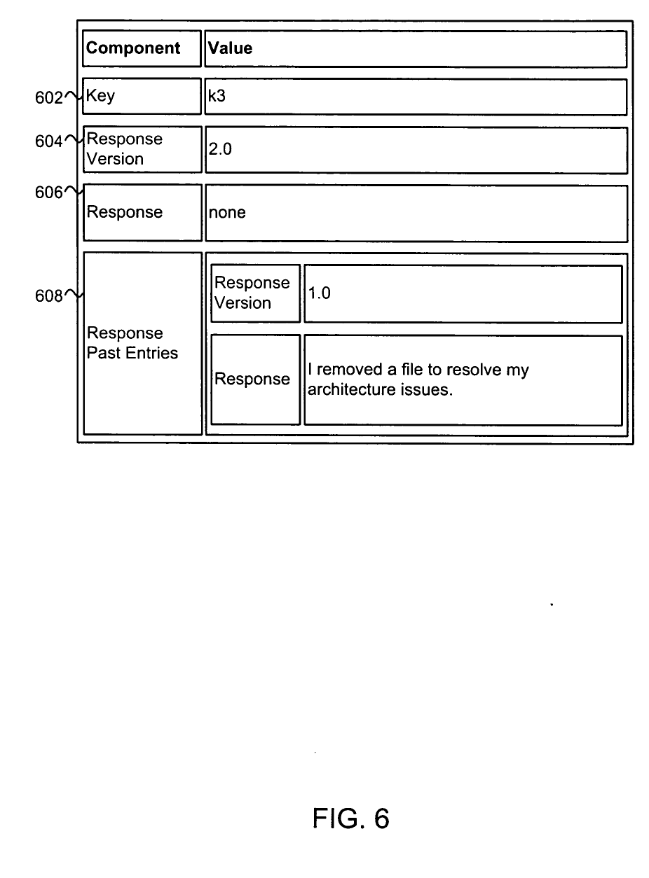

Note that the response component has been omitted from the prompt database entry of FIG. 5. In accordance with an embodiment of the invention, a response database is provided for storing the responses to the various prompts. To facilitate discussion, FIG. 6 provides a sample of an entry in a response database. Key component 602 has a value of ‘k3’, which corresponds to key component 502 in FIG. 5. Response version component 604 identifies the version of the prompt database that is used when response 606 is input by the user. In this database entry example, response version component 604 has a value of ‘2.0’, which shows that the current response entry is for the most recent prompt version. With respect to response component 606, the value of ‘none’ indicates that the user has not responded to version 2.0 of this step. Once the user has responded to the prompt, then the updated response is stored in the response database with a version number that is higher than versions in the response past entries component 608. As alluded to, response past entries component 608 stores all the past responses. For each response past entry, there are a response version and response components.

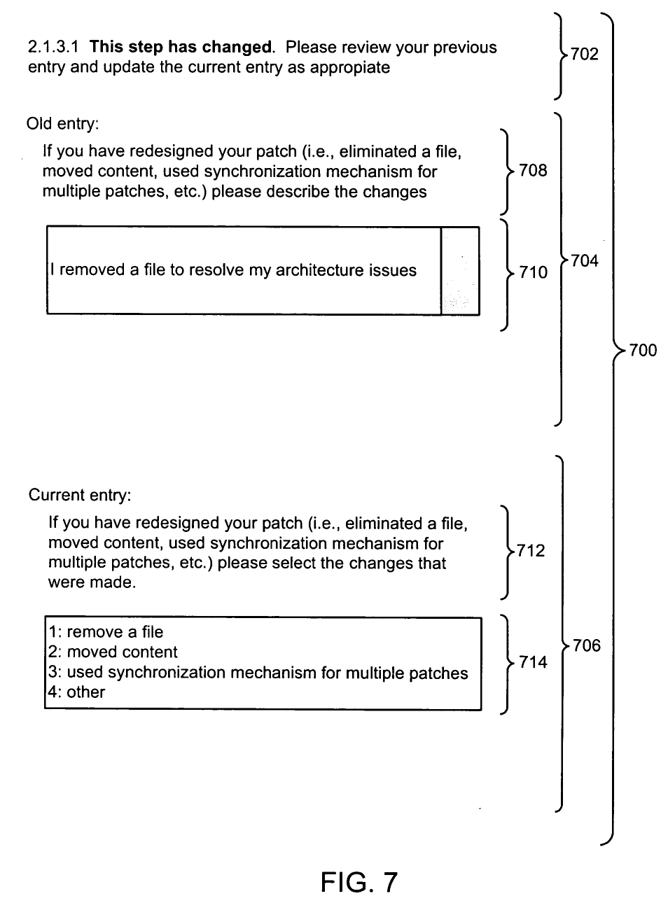

In the prior art, the previous version (prior art FIG. 2A) and the newer version (prior art FIG. 2B) of a prompt are not displayed as one unit. Unlike the prior art, FIG. 7 shows an embodiment of the invention where the managed update system displays a prompt that may reflect previous version prompt and response component along with the newer version prompt.

In the example of FIG. 7, prompt 700 has three sections. Section 702 may include the location and the update guidance indicating that the prompt has changed. Section 704 may include the previous version of the prompt text 708 (which includes values from the prompt past entries component 522 in FIG. 5) with the corresponding past response 710 (which includes values from the response past entries component 608 in FIG. 6). In other words, section 704 may include the completed process step and response from the previous version. If more than one entry exist in the prompt past entries component 522 (FIG. 5) and response past entries component 608 (FIG. 6), then the most recent version is displayed. However, if so desired, more than one previous version may be displayed.

Section 706 may include the new updated prompt text 712 and response section 714. Prompt text 712 may include prompt text component 520 in FIG. 5. Response section 714 may include a response type component 518 (FIG. 5). In this example, response type component is a combo box.

In the new inventive database structure, some of the additional new components may be optional. An embodiment of this invention may employ some or all of the following components: prompt version, response version, prompt past entries, response past entries, and update action. With these components and the components from the prior art, the managed update system is still able to guide a user through a process and handle changes that may occur while the user is part way through a dynamic process.

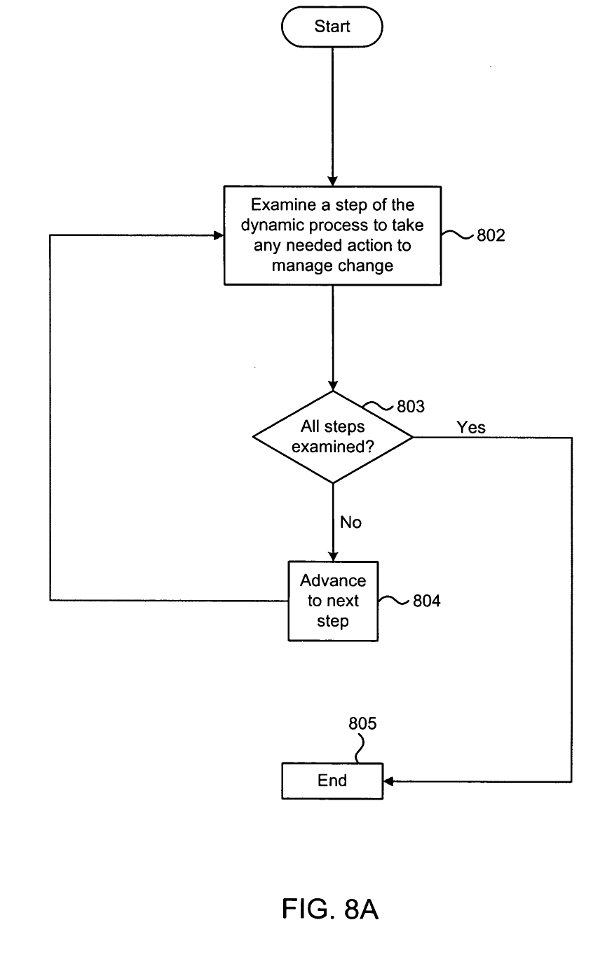

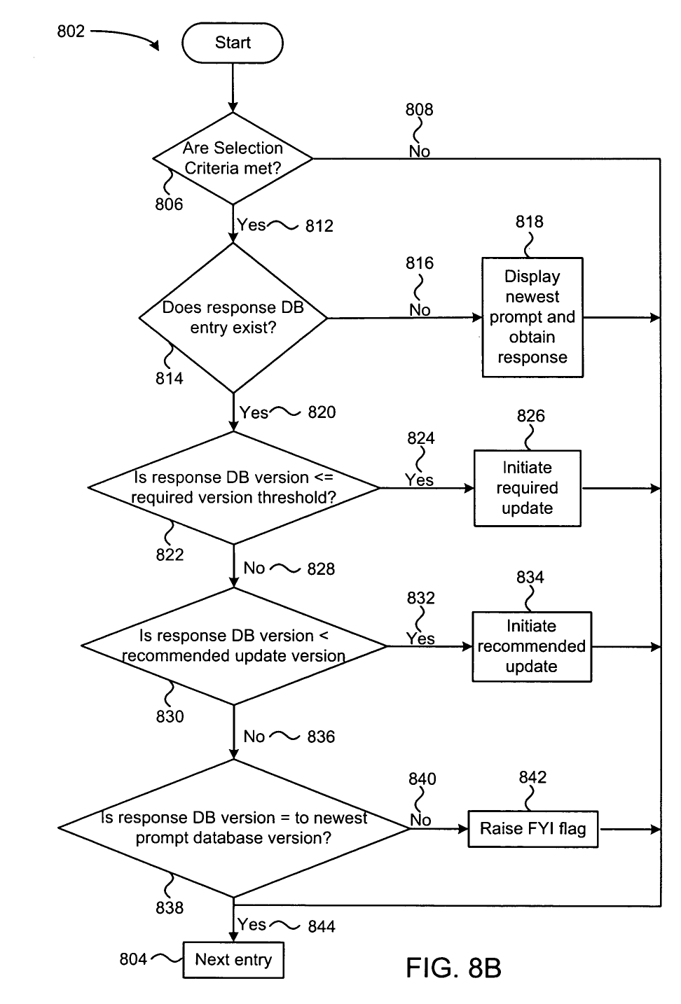

FIG. 8A shows, in accordance with an embodiment of the invention, a high-level view of an algorithm for managing changes to a dynamic process while the user has only partly completed that dynamic process. Each time a user accesses a PCDPE, the managed update system examines each step of the dynamic process to handle changes that may have occurred (algorithm step 802). The managed update system analyzes each step based on the location component, since the location component permits the order of the steps to be tracked.

After completing algorithm step 802, the managed update system determines at algorithm step 803 whether or not all steps have been examined. If all steps have been examined then the managed update system ends the process at algorithm step 805. If all steps have not been examined, then the managed update system advances to the algorithm step 804 and proceed to start the cycle again at algorithm step 802.

The analysis that is being performed at algorithm step 802 is further discussed in FIG. 8B. To facilitate discussion, FIG. 8B shows, in accordance with an embodiment of the invention, an algorithm for managing changes to a dynamic process while the user has only partly completed that dynamic process. In analyzing the step, if the selection criteria are not met in algorithm step 806 then the managed update system proceeds via path 808 to algorithm step 804 to examine the next entry. However, if the selection criteria in algorithm step 806 are met, then the managed update system proceeds via path 812 to the next algorithm step.

At algorithm step 814, the managed update system checks the response database for a response. If there is not a response to the newest version of the prompt, then the managed update system proceeds via path 816 to algorithm step 818, which displays the newest prompt and obtains a response therefor. After displaying the newest prompt and obtaining a response from the user, the managed update system proceeds to algorithm step 804 to go to the next entry. If there is an entry for the response to the newest version of the prompt in the response database, then the managed update system proceeds via path 820 to the next algorithm step.

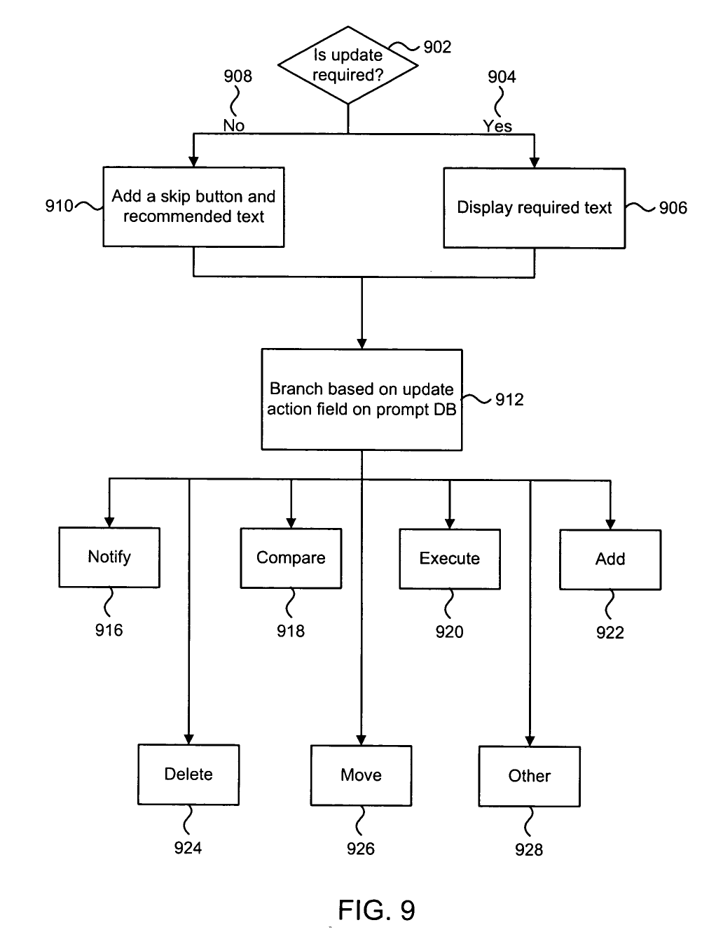

At algorithm step 822, the managed update system determines whether the response version in the response database is less than or equal to the required version threshold. If ‘yes’, then the managed update system proceeds to algorithm step 826 via path 824. At algorithm step 826, the required update is initiated. The update process for algorithm step 826 is discussed later in FIG. 9.

If the response version in the response database is greater than the required version threshold, then the managed update system proceeds via path 828 to algorithm step 830 to ascertain whether or not the response version in the response database is less than the recommended version threshold. If the response version in the response database is less, then the managed update system proceeds to algorithm step 834 via path 832. Algorithm step 834 initiates the recommended update. Details pertaining to algorithm step 834 are provided later in FIG. 9.

If the response version in the response database is greater than the recommended version threshold, then the user proceeds via path 836 to algorithm step 838. A final check of the response version in the response database is made against the current prompt database. If the versions are not the same, than the managed update system proceeds down path 840 to provide a courtesy notification at algorithm step 842. If the versions are the same in the two databases, then the managed update system proceeds via path 844 to the next entry 805 to examine the next entry.

As mentioned above, if the response version in the response database is not greater than either the required version threshold or the recommended version threshold, then the managed update system initializes a required update or a recommended update respectively. FIG. 9 illustrates the update process, either a required update or a recommended update that a managed update system may perform. At algorithm step 902, if a determination is made that an update is required, then the managed update system proceeds via path 904 to algorithm step 906. At this algorithm step, the managed update system displays guidance text, which for example indicates that the user has to make the update. If an update is not required, then the managed update system proceeds via path 908 to algorithm step 910. At algorithm step 910, the managed update system displays guidance text, which for example indicates that the user is recommended to update the response; however, an update is not required and a ‘skip’ button may be provided to allow the user to bypass this step. In algorithm step 912, the specific update action is ascertained, based on the value of the update action component in the database (i.e., 524 in FIG. 5).

If an update action relates to a notify action 916, the managed update system alerts the user that that a new version of the prompt is available. The user is recommended to read the previous version response to determine if the response needs to be updated. For example, the user has responded to step 2.1.3. Upon logging on, the user is notified by the managed update system that an update has occurred to step 2.1.3. Since the update action associated with the change to step 2.1.3 is a notify action, the managed update system may display the previous version response with the new version prompt. At this point, the user may be given the option of updating or ignoring the change.

Another update action that may be associated with a change is a compare action 918. A compare action is similar to a notify action; however, with a compare action, the managed update system displays the previous version prompt and response along with the new version prompt and may highlight the difference. If, for example, both the previous and the new version prompts are in a free-form text format, then the managed update system may highlight the difference between the two prompts.

Another update action that may be employed is execute action 920. With the execute action, the managed update system employs a specified program or some code to perform the update. For example, an execute action may provide the syntax of a program (script to execute) to manage the transition from the previous version to the current version. This program may either perform the transition with no additional input or may prompt the user for further information to manage the transition. In an embodiment, the input to the program is the response database entry using the previous prompt database entry. The output is a new response database entry based off of the latest prompt database entry.

An update action of add 922 allows the managed update system to display a new prompt with blank response to the user. In other word, the prompt relates to a new entry on the prompt database. Note that a new prompt may not always be presented to all users because the managed update system may condition the presentation on whether a prompt is relevant to a user.

Another update action is a delete action 924. A change that is related to a delete action requires the managed update system to make the prompt unavailable to all users. Suppose the user already responded to step 2.1.3, and step 2.1.3 is no longer present in the new version of the dynamic process. With the new change, the user is informed that step 2.1.3 has been deleted and the user may be given the option to save the response to the deleted step for personal use.

Another update action that may occur is a move action 926. With a move action, the managed update system changes the location of a prompt (which changes the order of presentation of the prompt in the process). In other words, the prompt that has been changed is renumbered and all prompts that have a higher location number may also be renumbered. Note that a move action does not impact the response. For example, a step has been changed from a location ‘2’ to a location value of ‘3’. All prompts with a higher location number, which means prompts greater than a location of 2, may be renumbered. However, none of the responses associated with the prompts that have been renumbered are impacted due to the move action

Beside the update actions discussed above, there may be other update actions 928. The update actions listed are just examples of the capability of the managed update system.

As can be appreciated from the foregoing, embodiments of the invention increases the likelihood that the most recent version of a process is being utilized by all users. For example, the process developer may be assured that the recent changes that have been made are readily available to all user as soon as the prompt database has been updated because the managed update system automatically checks for any updates or changes on a prompt-by-prompt basis and informs the user and/or guides the user to conform to the new changes. The user appreciates the efficiency of not having to waste the effort already put into completed steps of a PCDPE. Furthermore, the user can be confident that the managed update system has bypassed all steps that do not pertain to the user and that the prompts displayed include all changes that may impact the user. Another benefit is a full record-keeping database that allows the user to leverage upon past responses.

While this invention has been described in terms of several embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for managing a partially completed dynamic process execution (PCDPE), said PCDPE representing a dynamic process that is partially completed by a user, comprising:
ascertaining whether a change has occurred to at least one of a prompt component and a response component associated with said dynamic process;
if said change has occurred, performing steps a) and b)
a) ascertaining whether a completed process step of said PCDPE requires updating responsive to said change; and
b) if said completed process step requires updating, performing an update action on said completed process step.

2. The computer-implemented method of claim 1 wherein said ascertaining whether said completed process step requires updating includes comparing a version number associated with said completed process step and a version number associated with a corresponding process step that has been changed.

3. The computer-implemented method of claim 1 wherein said version number associated with a corresponding process step that has been changed represents a required version threshold.

4. The computer-implemented method of claim 1 wherein said version number associated with a corresponding process step that has been changed represents a recommended version threshold.

5. The computer-implemented method of claim 1 wherein said performing said update action includes displaying a previously completed response for said completed process step.

6. The computer-implemented method of claim 1 wherein said performing said update action includes storing an updated response from said user into a database, said updated response being associated with a version number that is different from a version number associated with said previously completed response.

7. The computer-implemented method of claim 1 wherein said change occurred with respect to said prompt component, said performing said update action includes displaying a prompt response associated with said completed process step and a prompt response that resulted from said change.

8. An article of manufacture comprising a program storage medium having computer readable code embodied therein, said computer readable code being configured to manage a partially completed dynamic process execution (PCDPE), said PCDPE representing a dynamic process that is partially completed by a user, comprising:
computer readable code for ascertaining whether a change has occurred to at least one of a prompt component and a response component associated with said dynamic process;
computer readable code for performing steps a) and b) if said change has occurred, wherein
step a) involves computer readable code for ascertaining whether a completed process step of said PCDPE requires updating responsive to said change; and
step b) involves computer readable code for performing, if said completed process step requires updating, an update action on said completed process step.

9. The article of manufacture of claim 8 wherein said computer readable code for ascertaining whether said completed process step requires updating includes computer readable code for comparing a version number associated with said completed process step and a version number associated with a corresponding process step that has been changed.

10. The article of manufacture of claim 8 wherein said version number associated with a corresponding process step that has been changed represents a required version threshold.

11. The article of manufacture of claim 8 wherein said version number associated with a corresponding process step that has been changed represents a recommended version threshold.

12. The article of manufacture of claim 8 wherein said computer readable code for performing said update action includes computer readable code for displaying a previously completed response for said completed process step.

13. The article of manufacture of claim 8 wherein said computer readable code for performing said update action includes computer readable code for storing an updated response from said user into a database, said updated response being associated with a version number that is different from a version number associated with said previously completed response.

14. The article of manufacture of claim 8 wherein said change occurred with respect to said prompt component, said computer readable code for performing said update action includes computer readable code for displaying a prompt response associated with said completed process step and a prompt response that resulted from said change.

15. A computer-implemented method configured for managing a partially completed dynamic process execution (PCDPE), said PCDPE being associated with a given version of a dynamic process, said PCDPE involving at least one completed process step and at least one incomplete step, comprising:
ascertaining whether a subsequent version of said dynamic process involves a change to said at least one completed process step; and
if there exists said change, performing an update action on said at least one completed process step.

16. The computer-implemented method of claim 15 wherein said update action is performed using information furnished by said subsequent version of said dynamic process.

17. The computer-implemented method of claim 16 wherein said performing said update action includes displaying a previously completed response for said at least one completed process step.

18. The computer-implemented method of claim 16 wherein said performing said update action includes storing an updated response from said user into a database, said updated response being associated with said subsequent version.

19. The computer-implemented method of claim 15 wherein said change occurred with respect to a prompt component of said PCDPE, said performing said update action includes displaying a prompt response associated with said at least one completed process step and a prompt response that resulted from said change.

20. The computer-implemented method of claim 15 wherein said updating action includes obtaining an updated answer for said at least one completed process step and storing a previously completed answer associated with said at least one completed process step,
